(19) United States
(12) Patent Application Publication
(10) Pub. No.: US 2007/0239721 A1
(43) Pub. Date: Oct. 11, 2007

(54) Cross-entity sales lead rights assignment and action planning system

(76) Inventors: Matthew Royce Ullman, Seattle, WA (US); Randy N. Moran, Poulsbo, WA (US)

Correspondence Address: STOEL RIVES LLP - SLC, 201 SOUTH MAIN STREET, ONE UTAH CENTER, SALT LAKE CITY, UT, 84111, US

(21) Appl. No.: 11/391,963

(22) Filed: Mar. 29, 2006

(51) Int. Cl. G06F 17/30

(52) U.S. Cl. 707/9

(57) ABSTRACT

A sales lead server is accessible over a network and hosts databases containing static and active content related to sales leads. The server includes a memory to store records of databases containing static and active content, a database manager to render databases with the static and the active content in memory relative to one another, the database manager to perform a method, including enabling a user to create a lead-related right for each lead, and to create rules associated with each lead that cause the database manager to assign to a selected lead-handling entity the lead-related right for the lead. The database manager includes a lead rights assignor that automatically applies the assignment rules to assign to the lead-handling entity the lead-related right for each lead. A communication module in communication with the database manager automatically communicates to the lead-handling entity the assigned lead-related right to the lead.

### TECHNICAL FIELD

This disclosure relates generally to management of sales leads, and more particularly to a system for assigning and tracking sales leads, including rights and action plans affiliated therewith.

### BRIEF DESCRIPTION OF THE DRAWINGS

Non-limiting and non-exhaustive embodiments of the disclosure are described, including various embodiments of the disclosure with reference to the Figures, in which:

FIG. 1 is a block diagram of an embodiment of a cross-entity sales lead rights assignment and action planning system;

FIG. 2 is a representation of an example of a business association network mimicking cross-entity business relationships, from the perspective of users.

FIG. 3 is a representation of another example of a business associations network mimicking cross-entity business relationships, from the perspective of users.

FIG. 4 is a table illustrating configuration options for values displayed in databases of the system of FIG. 1;

FIG. 5 is a flow chart for configuring the output structure of the system of FIG. 1;

FIG. 6 is a flow chart for configuring the roles and privileges of users of the system of FIG. 1; and

FIG. 7 is a flow chart of a method for implementing the sales lead rights assignment and action planning system of FIG. 1.

### DETAILED DESCRIPTION

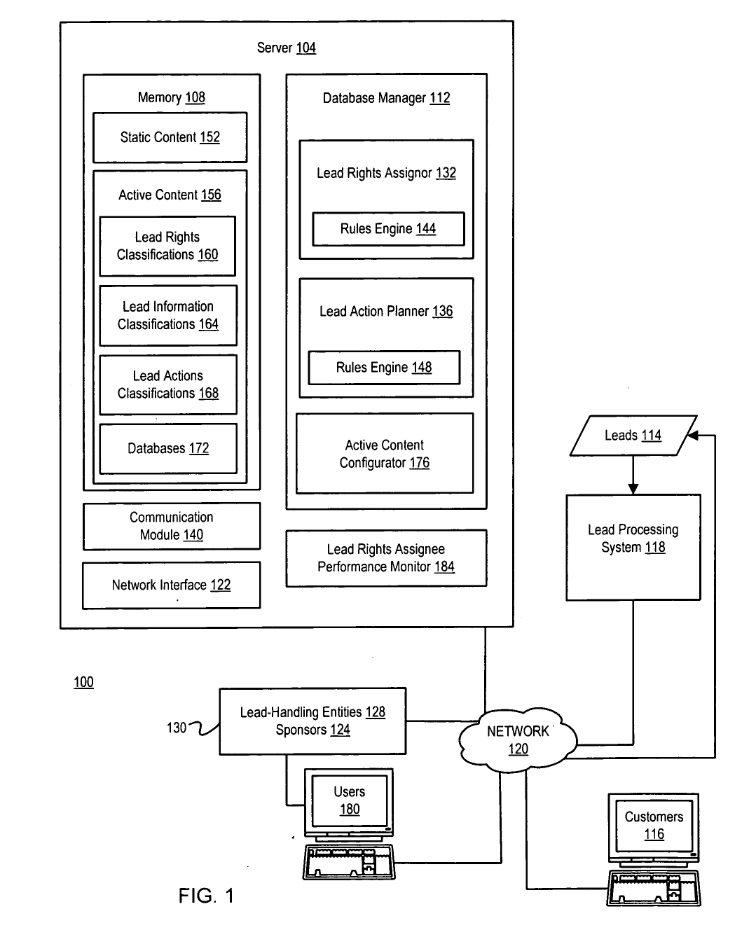

The embodiments of the disclosure will be best understood by reference to the drawings, wherein like parts are designated by like numerals throughout. It will be readily understood that the components of the present invention, as generally described and illustrated in the Figures herein, could be arranged and designed in a wide variety of different configurations. Thus, the following more detailed description of the embodiments of the apparatus, system, and method of the disclosure, as represented in FIGS. 1 through 6, is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known structures, materials, or operations are not shown or described in detail. Furthermore, the described features, structures, or characteristics may be combined in any suitable manner in one or more embodiments. It will also be readily understood that the components of the embodiments as generally described and illustrated in the Figures herein could be arranged and designed in a wide variety of different configurations.

The order of the steps or actions of the methods described in connection with the embodiments disclosed may be changed as would be apparent to those skilled in the art. Thus, any order in the Figures or Detailed Description is for illustrative purposes only and is not meant to imply a required order, unless specified to require an order.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Referring to FIG. 1, a block diagram is shown of one embodiment of a cross-entity lead rights assignment and action planning system 100 (or “the system”), which may be substantially or completely automated. The system 100 may be operable on a computer or server 120 having a memory 108 and a database manager 112 and may include computer readable instructions. Each lead 114 may be generated from a variety of vehicles, such as e-mail responses, web-site forms, direct mail lists, and telephone contacts. The leads 114 may include information about a current customer 116 or a potential customer 116, such as a person who responds to an advertisement or has filled out an information request submission page on the Internet, indicating interest in a merchant's products, which include goods and/or services. The leads 114 may also include, or be affiliated with, contact information and personal information, such as personal preferences regarding the subject matter of the lead 114. This information may be exposed as human readable fields in database records for accessibility.

The lead 114, including both the above-described information and meta-data, is directly or indirectly forwarded from a lead creator or owner to a lead processing system 118 over a network 120 and using a network interface 122 of the server 104. The network 120 may include the Internet or World Wide Web, or an intranet such as a LAN or WAN, or any other network of communicating computerized devices having a memory 108. The lead processing system 118 may then process each owner-identified lead with any method of initial filtering. “Meta-data” may include owner-specific information and/or comments within the lead 114 record or file.

“Owner-identified” refers to each lead 114 carrying ownership information along with it as it passes through the system 100. Ownership of the lead 114 is enjoyed by the business entity (hereinafter “a sponsor” or “sponsoring entities” 124) that has received the lead 114 directly from a prospective customer 116 without intermediation by another lead-handling entity 128, purchased the lead, or otherwise obtained control or proprietary rights over the lead. Ownership may be explicit in the lead information when it arrives at the lead processing system 120, or may be inferred by the lead processing system 120 using lead meta-data. Lead meta-data pertaining to the owner, such as the source that forwarded the lead 114 to the lead processing system 120, may be mapped to the owner of the lead 114. For ease of reference, where appropriate, sponsoring entities 124 and lead-handling entities 128 may be jointly referred to as “business entities” 130.

Business entities 130 (or “entities” 130) may be independently incorporated, controlled, or governed business organizations, to include, without limitation, a partnership, limited liability company, association, corporation or a government unit. Entities 130 span a range of lead-related roles, such as product vendors (or merchants) as well as affiliates of the lead-owner, the latter being considered sponsors 124 where identified as a sub-component of a lead-owner having more than a mere supporting role. Sponsors 124 may thus include not only the original lead owner, but also subsidiaries of parent sponsors 130, such as, to use the automobile industry only to illustrate, an automobile original equipment manufacture (OEM), a financing company, and a marketing company, all whose businesses are integrated with a corporate parent, such as GM®. Those skilled in the art will appreciate that the principles taught herein may be applied to any industry that uses sales leads as a part of its marketing efforts.

Product vendors, usually considered lead-handling entities 128, may include the ultimate seller of a product, such as an automobile dealership, as well as dealer groups that manage the dealerships. Affiliates may include business entities 130 playing an administrative, managerial, or other value-added support role for the system sponsor 124 and/or a lead-handling entity 128. Examples of “affiliates,” therefore, may include a call center, a quality monitoring organization, a business analytics company, another lead distribution organization, and a lead-enhancement company that may attach demographic-type and other related information to a lead 114.

A sponsoring entity 124 may assign certain lead-related rights to multiple lead-handling entities 128. For example, different rights may be assigned to one or more lead-handling entities 128 to enable different lead handling activities, e.g., to enable one entity 128 to fulfill the customer 116 request and another entity 128 to monitor the quality of that fulfillment effort, such as by conducting a customer 116 satisfaction survey. On the other hand, the same set of rights may be assigned to multiple lead-handling entities 128 for various purposes, such as to foster competition with regard to whatever handling is prompted by those rights, such as to enable multiple entities 128 to compete for the business of customers 116.

The rights assigned to a selected entity 128 may be complete, to the extent of transferring ownership of the leads 114, or limited, permitting only certain types of activities with respect to the leads 114. For example, one lead-handling entity 128, such as a dealer, may enjoy a right to work (or directly respond to) a lead 114 that differs from a right assigned to another lead-handling entity 128, such as an affiliate business analytics company, to view a lead. Lead handling entities 128 may utilize various systems for managing the manner in which they handle leads 114 to which they have assigned rights. These intra-entity lead management systems may be distinct systems that are incompatible, non-intercommunicating, or non-integrated with the systems used by other business entities 130 within a system sponsor's 124 network or within units of the same selected entity 128.

The database manager 112 may include a number of sub-modules for communicating electronically with databases resident in memory 108, and for linking pertinent data throughout memory 108 to a record of any given database. As discussed, the memory 108 may be resident on a single server 104 or found across several memory devices. One sub-module may include a lead rights assignor 132 to, among other things, process leads 114 to select from among identified lead-handling entities 128 one to which to assign a right affiliated with a lead 114, and to determine what associated information to expose. The lead rights assignor 132 may also receive a list of criteria that, if not met by the selected lead-handling entity 128, may require the lead-related right to be revoked. Another sub-module may include a lead action planner 136 to process leads to determine if a lead 114 requires any lead-related actions from which to develop a lead action plan that a selected lead-handling entity 128 must (or is suggested that it) comply with in handling the lead 114.

A communication module 140 may automatically communicate identified information about each lead 114, along with affiliated rights and action plans, to one or more lead-handling entities 128 over a network 120. “Automatically” herein connotes without direct user intervention, and may additionally connote that an action is carried out as a computerized automated process. The communicated rights affiliated with a lead 114 may include permission to make some level of contact with the targeted prospective customer 116, or to attempt to sell to that prospective customer 116 lead-related subject matter. In addition, the communication of lead-related rights and action plans may be indirect, such as by updating a web page from which a lead-handling entity 128 may retrieve the information communicating such rights and action plans.

Once the owner-identified lead 114 is received, the lead rights assignor 132 automatically activates a corresponding rules engine 144. The rules engine 144 communicates electronically with the memory 108 to determine what rights are to be affiliated with the lead 114, and what lead information is to be exposed with those rights to the selected lead-handling entities 128. As a consequence, some lead information fields, or parts of fields, of a database record may be blocked from access (or viewing) by an identified lead-handling entity 128 who is assigned a right to a lead 114. In addition, the lead action planner 136 automatically activates another rules engine 148, which also electronically communicates with memory 108, to there retrieve any lead actions that it determines should be associated with the assigned lead-related rights. The lead action planner 136 rules engine 148 may use such lead actions to create a lead action plan to require, or suggest how, an identified lead-handling entity 128 is to handle an assigned lead right.

Depending upon specific implementation needs, such rules engines 144 and 148 may be incorporated within the system using available third-party software components or through the development of custom software, as is well known in the art. For example, the specification for the Java® Rule Engine Application Programming Interface (API) (JSR 94), developed through the Java® Community Process (JCP) program, defines a Java® runtime API for rule engines by providing a simple API to access a rule engine from a Java® Platform, Standard Edition (Java® SE, formerly known as J2SE) or a Java® Platform, Enterprise Edition (Java® EE, formerly known as J2EE) Java® technology client. Consequently, if the system 100 is implemented as an extension of such a platform, available rules engines such as Drools™, Fair Isaac Blaze Advisor™, ILOG® JRules, and Jess® that support JSR 94 may be used.

The memory 108 may include static content 152, or database content such as the formatting of fields within a record and of records within a database, as well as other hard-coded aspects of database programs known in the art. All other content within memory 108 is regarded as active content 156, which includes identifiable objects that may be modified by users. Except upon initial creation, static content 152 remains unchanged. A template may define the layout for the static content 152 and the location of active content 156 relative to the static content 152. Such a template allows programs implementing the database manager 112 to search in general blocks of memory 108 for data to be acted upon. As such, active content 156 is not constrained to a fixed memory location. Such blocks of data in the memory 108 may include, for instance, lead rights classifications 160, lead information classifications 164, lead actions classifications 168, and databases 172, each of which will be referenced in more detail below.

Another sub-module of the database manager 112 may include an active content configurator 176, which communicates electronically with the memory 108 to customize the active content 156 of a sales lead rights assignment and action planning system 100 to the needs of one or more sponsors 124, and their affiliates, as further discussed below. In the alternative, the database manager 112 may itself perform the functions of the active content configurator 176 as an integrated function of software that manages the databases of the system 100. As a consequence, although the active content configurator 176 may be referred to herein, in the broadest sense, it is the database manager 112 at work when configuring the system 100.

If implemented as a separate software module, the active content configurator 176 may be used, among other things, to establish the privileges for configuring the system 100 in order to coordinate efforts from various participants in the hierarchical network of one or more sponsors 124, in accordance with a set of sponsor-defined requirements. This configuration is executed by users 180 who may first access the database manager 112 over the network 120, such as by login, in order to receive authorization to access the active content configurator 176. A sufficiently privileged user 180 creates or otherwise modifies configuration privileges, which themselves are active content 156, for a given version of the system 100. These users 180 are usually individuals associated with system sponsors 124, although lead-handling entities 128 may also be afforded a level of configuration access.

Commonly, in order to accomplish this, a system sponsor 124 may first assign one or more users 180 associated with the highest branch of the system sponsor's network of business entities 130 to a special role of system 100 administrator having full privileges for configuring the system via the active content configurator 176. The designated system administrator initializes the system 100 with a set of configuration privileges and roles, and assigns other users 180 to these roles, thereby enabling other users 180 to potentially also configure aspects of the system 100.

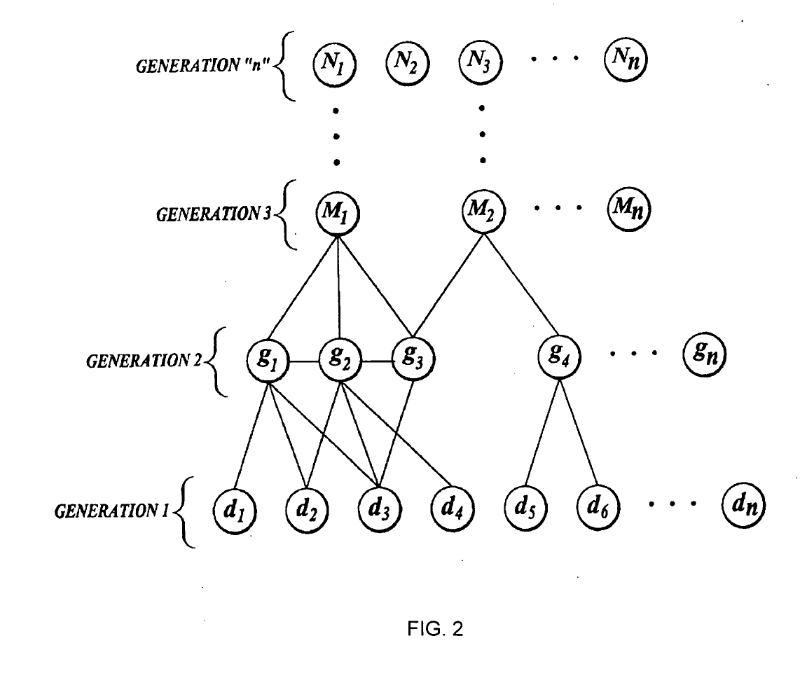

Once the active content configurator 176 (or database manager 112) checks the role assigned to any user 180, the user 180 is privileged to configure certain system 100 settings or active content 156 in accordance with the “precedence” of the user 180 (hereinafter “active content” will include any configurable setting or data value of the system 100). The “precedence” is determined by the one or more assigned roles of the user 180 of a business entity 130 having a plurality of business associations (mimicking real-world relationships) with other business entities 130 at various levels of a sponsor's hierarchical network, as discussed in FIGS. 2-4. It is thus the role and these business associations that dictate precedence levels. Each role may afford the user 180 one or more specific configuration privileges, including permission to modify certain types of “unlocked” active content 156. Certain privileges may also enable a user 180 to “lock” unlocked values for active content 156.

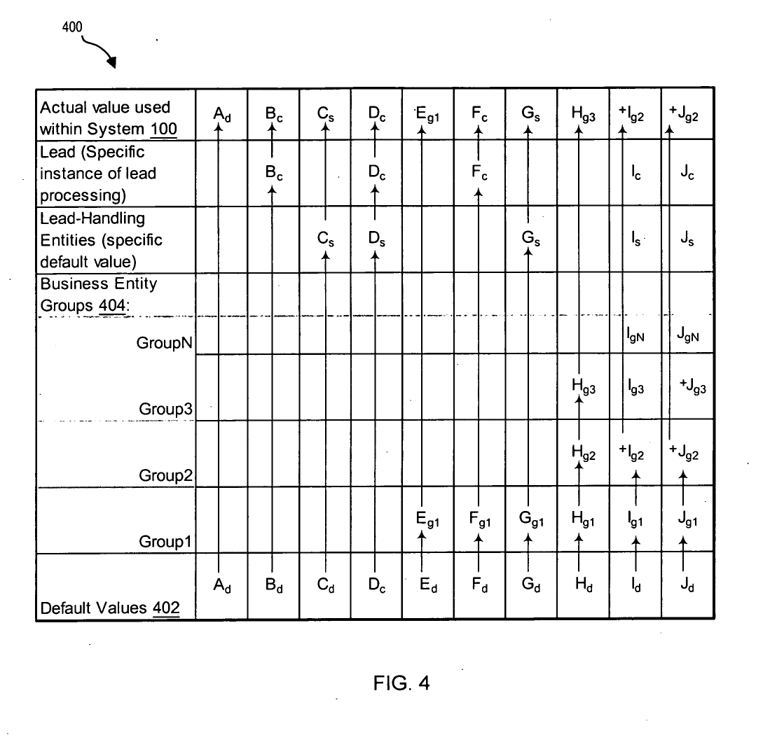

For a user 180 to exercise a privilege to modify the value of, and/or unlock, a locked active content 156 value, the active content configurator 176 compares the precedence value of the user 180 with the precedence value of the locked active content 156. The precedence value of active content 156 may be determined by the precedence value of the user 180 who previously locked it, or by other means as described with reference to FIG. 4. If the precedence value of the user 180 is greater than the precedence value of the locked active content 156, the active content configurator 176 may allow the user 180 to modify it. Roles and precedence-based locking will be discussed in more depth with reference to FIGS. 2 through 6.

Configuration may also include a sufficiently privileged user 180, such as an administrator, establishing a plurality of configuration privileges and mapping these privileges to specific, but varying, user 180 roles. The privileged user 180 may then associate these roles with other users 180 having access to the active content configurator 176 by virtue of the associations of the users 180 within the system network. Depending on the degree of privilege (based on roles), users 180 may create the different classifications or lists of referents (system outputs) that may result from the operation of the rules engines 144 and 148 under varying conditions. These referents include the types of lead rights that may be assigned, the types of lead information that may accompany the lead right, and the types of lead actions that may be required or suggested with an assigned lead right.

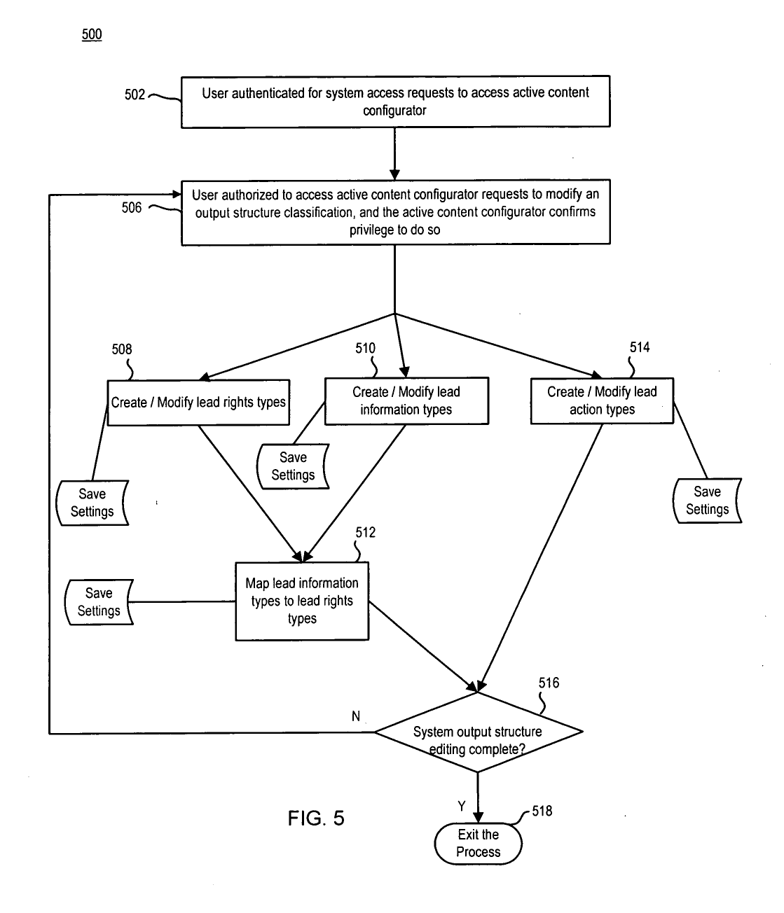

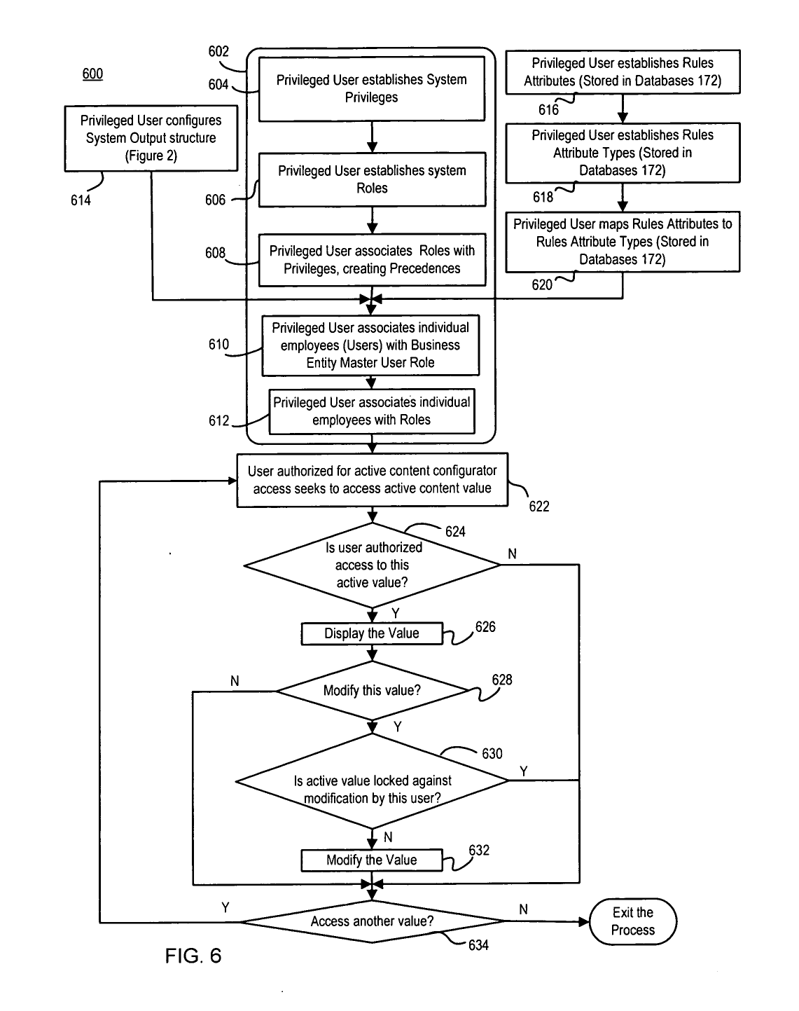

The active content configurator 176 may also enable an appropriately-privileged party to determine how the rules engines 144 and 148 process a lead 114 to assign particular rights, lead information, and actions from amongst those present within the referent classifications. Configuring the rules engines involves determining what attribute categories or kinds of information will be eligible for use by the rules engines 144 and 148, what particular attributes within the eligible attribute categories will be utilized by the logic in the rules engines 144 and 148, the logic for using the selected attributes, and the threshold values of those attributes. The logic and threshold values may jointly establish when the rules are met. The details of the initial set up by users 180 of these features will be discussed in more detail with reference to FIGS. 5-6.

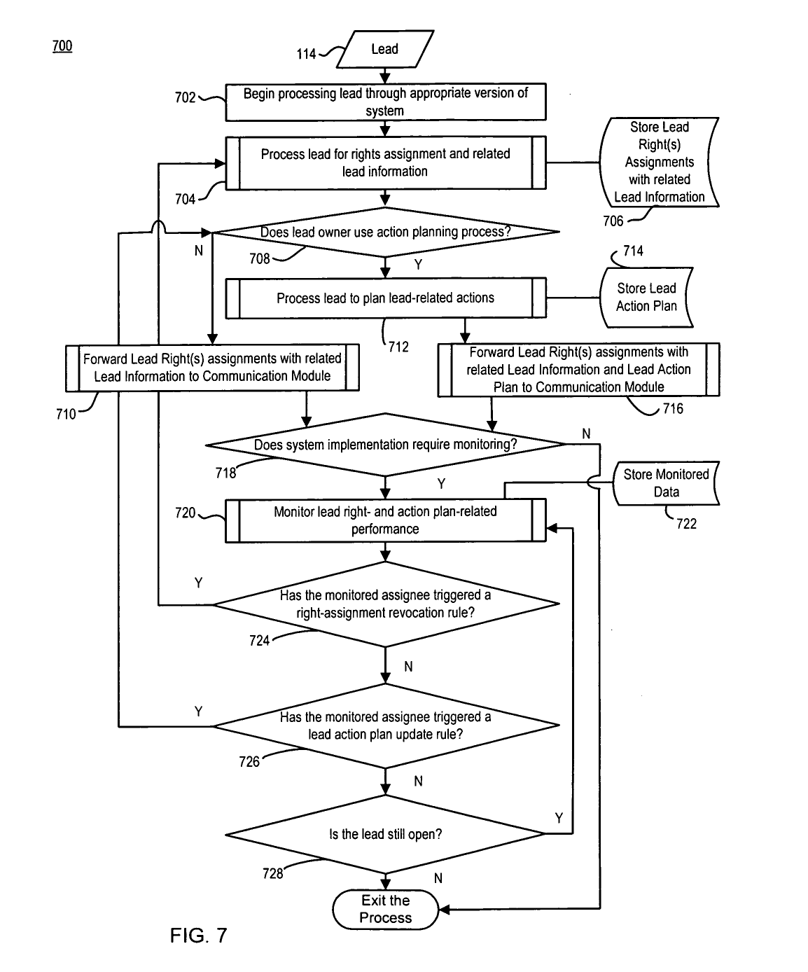

After one or more rights to a lead 114 has been assigned to a specifically selected lead-handling entity 128, a lead rights assignee performance monitor 184 (hereinafter “performance monitor”) may be used to track, continuously or periodically, performance with respect to the assigned lead right and/or proffered plan of actions according to a set of criteria. These criteria may be obtained by the performance monitor 184 through creation from within, importation from a database 172, or may be drawn from the rules engines 144 or 148. The results of the performance monitoring may be non-exclusively used for operational, analytic, or other purposes, as will be discussed with reference to FIG. 7.

Thus, the performance monitor 184 enables monitoring of data pertinent to lead rights-related performance by a specifically selected lead-handling entity 128 assigned an identified lead right, such as the right to work (or directly respond to) the lead. The performance monitor 184 may also monitor data pertinent to performance on proffered lead action plans established by the rules engine 148 of the lead action planner 136. Depending upon the needs of the system sponsor 124, the results of such monitoring is be processed by the system 100 to inform decisions as to whether penalties or rewards should be accorded a particular selected entity 128.

In one embodiment, the system 100 may directly impose a penalty of lead right revocation by using the results of such monitoring to enable the lead rights assignor 132 to apply one or more rules for revoking assigned lead-related rights. The revocation may be executed, for instance, by changing the status of the particular right from “Active” to “Inactive” for the selected lead-handling entity 128, along with related lead information as mapped from the lead information classifications 164. For example, such revocation rules may include contacting the customer 116 of the lead 114 within a set time period, else the system 100 may revoke the right of the selected entity 128 to work the lead, and so find and select the next best entity 128 candidate to work the lead, also in accordance with rules engine 144.

Monitoring may also be similarly implemented to ensure that lead action plans are complied with, where compliance is required when the lead action plan was generated by the lead action planner 136. Failure to comply may risk losing lead-related rights. Monitoring helps ensure that the lead action planner 136 generates an updated action plan for the lead 114, depending on how the lead action plan is handled by the selected entity 128, in comparison with a lead action update rule.

Also, in one embodiment of the system 100, the lead rights assignor 132 may be implemented to revoke rights to an individual lead 114 previously assigned to a selected lead-handling entity 128, and re-assign those rights to another entity 128. This is accomplished by configuring rules engine 144 with rights-assignment revocation rules for modifying the status of one or more rights to an individual lead 114 that have been previously assigned to a selected entity 128. If triggered, the rights-assignment revocation rules cause certain rights to be revoked from a selected lead-handling entity 128, and after re-routing the lead 114 back through the lead rights assignor 132, to possibly be re-assigned to another selected entity 128. Configuration of these rules by rules engine 144 may draw from required lead actions for the individual lead 114 identified by the rules engine 148 of the lead action planner 136.

For example, functioning of the rules engine 132 may include using monitoring-based information as to how the individual lead 114 is being handled at each of the one or more selected entities 128 assigned the “work the lead” right. The performance monitor 184 may obtain relevant information from the entities 128 by actively obtaining, or passively receiving, information related to working the lead. The rules engine 144 uses the information to determine whether to revoke the “work the lead” right from the selected lead-handling entities 128 whose monitored rights-related performance has triggered a rights-assignment revocation rule. The lead rights assignor 132 responds to the triggering of such a rule by changing the status of the right from “Initiated” to “Discontinued” for a selected entity 128 that triggered the revocation rule, and then re-routing the lead 114 back through the lead rights assignor 132 for assignment to yet another lead-handling entity 128.

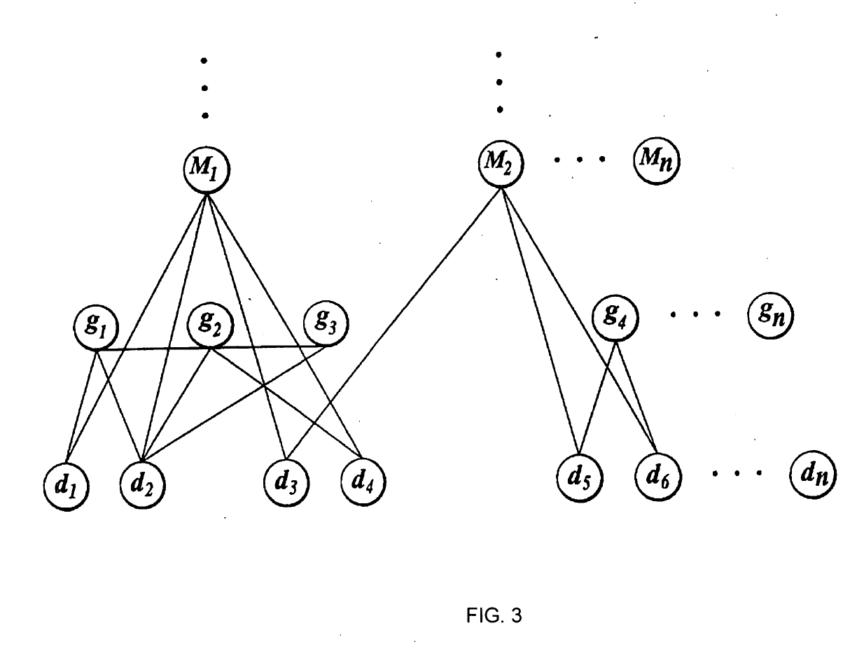

To better understand the concept of business entity associations in a cross-entity network, FIGS. 2 and 3 show examples of how such associations mimic business relationships of the users 180 having differing precedence levels to access and configure the system 100. FIGS. 2 and 3 display cross-entity relationships of potentially interlinking sponsored 124 network hierarchies. Business entities 130 were discussed previously, of which sponsoring entities 124 will usually have users 180 that may, most often, seek and be authorized to configure the system 100, as discussed with reference to the active content configurator 176 of FIG. 1. FIGS. 2 and 3 are also discussed with reference to a general “Business Services Platform,” of which the system 100 of FIG. 1 may be a “Module,” as taught in U.S. patent application Ser. No. 10/350,796 to Davis et al., entitled “Business Platform with Networked, Association-Based Business Entity Access Management and Active Content Website Configuration,” which is incorporated herein by reference in its entirety.

A business entity 130 in a network of sponsor 124 is part of a network of associated business entities 130 that mimic real life business relationships between these entities 130. The network is contextual in that it is role dependent. Thus for each user role, the network may be different from other user roles due to the nature of actual business relationships and information needs. Thus, whenever a new business entity 130 is added to the system 100, all that must be established are the roles of the users 180, and the other entities 130 already in the network with which it will have direct relationships through its normal course of business. This permits ease of adding new business entities 130 to the system 100 by establishing its “associations” in the network for each role. The active content configurator 176 may control the adding or modification of such business associations and roles, which may be stored in a database 172 of memory 108.

“Associations” represent the relationships between business entities 130 in the system 100; for example, OEMs, dealer groups, and dealers, in the automotive industry context. The active content configurator 176 must know, or have access to, business entity 130 associations to control access to and permitted use of business objects (“pieces of information”) in databases 172, or in other words, configurable active content 156 across these associations.

With reference to FIG. 2, an illustrative example of the role dependent networked business relationships that are emulated in the system 100, there are shown a number of business entities 130 (represented by circles) arrayed in series of “generations”. At the lower level, there is a group of business entities designated generation 1. Moving up the diagram, the next generation is generation 2, and so forth up to generation n. Thus, the business network can accommodate a large range of generations that have business associations with each of its neighboring generations, represented by the linking lines. For example, assume that the system 100 includes sponsors 124 in the automotive business industry. In this case, the business entities 130 (specifically, lead-handling entities 128) shown at the level of generation 1 may be visualized as automotive dealers. The business entities 130 shown at the level of generation 2 may be regarded as regional dealership groups (specifically, sponsors 124 or lead-handling entities 128); and the business entities 130 at generation 3 may be viewed as OEMs (specifically, sponsors 124). Clearly, the system network can accommodate more than three generations, but these three generations will suffice to explain how the business relationship configuration is used to control information access in the sales lead rights assignment and action planning system 100.

Note that dealer d2 belongs to both dealer group g1 and dealer group g2. This is a real life situation, in which a single dealer may be franchised to sell two different product lines, for example Saab and Volkswagen cars. Accordingly, dealer d2 will have a business relationship with two regional dealer groups, as shown by the association between them. Likewise, dealer d3 has associations with three dealer groups (g1, g2 and g3), because it sells three different product lines, and is therefore affiliated with three different dealer groups. On the other hand, dealers d1 and d5 each only associate with a single dealer group, since they have only one franchise each.

Note further that at the second generation level, some of the regional dealer groups g1, g3, and g3 have associations with each other. This association between dealer groups is also based on business relationships. For example, one dealer group may be based in Seattle, while another might be based in Denver, but both dealer groups sell the same line of automobiles. Accordingly, it may be necessary and desirable for an exchange of information regarding sales, marketing and other business information regarding sales of an automobile product line in the two regions. As a general rule, such associations between colleagues of the same generation can be established for any generation, based on the existing business relationships.

At the generation 3 level, the automobile manufacturers, tire manufacturers, and other suppliers of original equipment (OEMs) have associations with the regional dealer groups, and may have access to certain information of these. However, each OEM is restricted to access only information relating to its products, and not product lines of other OEMs, as explained below, through configuration of business objects and taking into account user roles.

For the sake of simplicity, one can view the above described “generational” business relationships as “parent-child” relationships, where the OEMs are parents, the dealer groups are children, and the dealers are “grandchildren”. The dealers stand as “children” to the dealer group “parents”.

Additionally, there is in FIG. 2 no direct relationship shown between generations 3 and 1. The only communication is through generation 2. This is not always the case. In many circumstances, depending upon user role, direct associations between generations 1 and 3 is a reality of the actual business relationship. Thus, FIG. 3 illustrates this role-dependent nature of the networked associations. For example, a user 180 at an OEM might want access to dealer sales statistics and lead-handling statuses for sales training scheduling reasons. This can be effected through direct information transfer from dealer to OEM once the association between the two is present in the system 100, for instance as stored in a database 172, for the user 180 seeking the information.

Note further that the network is fully recursive; so that, for example, when OEM M1 seeks permitted information from dealer group g1, it also has access to permitted information through g1 to information from d1. This recursiveness is a significant feature that simplifies the adding of new business entities to the networks: only immediate or closest business relationships must be mimicked by associations with already existing entities in the network, other associations result automatically from prior established associations of the already existing business entities 130. Thus if d3 is newly added, only associations with g1, g2, and g3 need be specified. The associations with M1 result automatically by recursion.

The above discussion, relating to FIG. 2, sets forth a basic notion of associations between the business entities 130. However, as explained, business entity associations are also contextual in the sense that they are dependent upon the role of the user 180 (“role-dependent”) within the business entity 130. Therefore, for example, the networked association illustrated in FIG. 2 may relate to the role of a sales manager for one of the dealer groups, or for any one of the other generations shown. The information requirements of a marketing manager of one of the business entities 130 might be quite different, and could be illustrated as shown in representative diagram FIG. 3, for example.

In FIG. 3, it can be seen that there are now direct associations between generation 3, the OEMs in the automotive context, and generation 1, the dealers. This direct association may be necessary for the dealers to update, for instance, sales lead action plans and the handling statuses of assigned lead-related rights. This kind of information may provide the OEMs with valuable ability to learn from their dealers how to create better action plans, and track the way selected lead-handling entities 128 are handling their specific assigned lead-related rights. In addition, such an information flow may provide a valuable source of consumer feedback regarding the utility or desirability of different action plans for an automobile (or other product) lead. Accordingly, the system 100 uses a flexible range of parameters based on business entity association in the context of user role, and business object configuration to control access to pertinent information in the same way that businesses in the real world would want to structure their informational relationships. As such, direct associations described above may be both necessary and desirable, and may reflect real life relationships.

From the foregoing, it should now be apparent that the role of user 180 plays an important part in establishing the associations between business entities 130 for persons in that particular role; i.e. the associations are role-based. Thus, each business entity 130 may have as many networked associations as it has user 180 roles; one of these networks corresponding to each of its roles that has access as a user 180.

The active content configurator 176 also controls access to information, as most broadly defined, through configuration of its “business objects,” or in this context, active content 156 that is intended to be shared. The information to be shared is not narrowly defined or restricted, but can be any information in memory 108 located across any number of memory-accessible devices.

Each of the business objects is configured for permission or denial of access depending upon the role of the user 180 seeking access, or in the alternative, depending on the precedence value of the user 180. Further, in the event access is not denied, but is granted, access can be restricted in several ways by object configuration. For example, the business object may be configured to deny access completely to a user 180 with a particular role or to permit “view only” access, or access to manipulate or modify, which can be further restricted to edit, supplement, create, and/or delete. Further, access may be restricted, based on user, and business object configuration, to permit or deny the user the right to aggregate information to generate the reports that include the particular business objects.

Thus, for example a parent (e.g. dealer group) may have access to all children (dealers in its group) sets of current sales lead rights and related lead information sets, and can run a report showing all of this. But, the child may or may not have permission to generate or view the same report. In some instances, a user 180 may only be allowed to see part of a report or to generate a report based on only certain information allowed for that user 180. That there are parts of the report or information withheld from this user 180 would not be apparent to the user 180. Users 180 of each business entity 130 may receive permissions to view or somehow modify all, some, or none of the reports or database information associated with their own business entity 130. The right to modify may include the right to edit, create, supplement, delete, or otherwise change the related active content 156. In particular cases, users from non-associated business entities 130 may also be expressly granted roles and permissions bypassing any (lack of actual) business relationship. This is not common, however.

When a user 180 logs into the system 100 to access the active content configurator 176 of the database manager 112, the usual precautions are taken to authenticate the user by login ID and password, or by other means. Once the user 180 is logged in, and his/her role is identified, the user 180 can look at and manipulate all information available to his/her role and business entity 130 to which he/she belongs, without any appearance via the user interface that not all the system information available is available to the user 180. The user 180 can access information to which it is allowed access (based on role and business entity 130 associations, i.e. “precedence value”), and can manipulate it to the extent that the precedence value of the user 180 exceeds the locked value of the active content 156 sought to be modified.

The addition of new business entities 130 is also straightforward. Once all roles of the new entity 130 are established, and relationships for each role with its parent, child and sibling business entities 130, associations are set up for each role. This automatically sets up other relationships in the network based on prior associations of the parent, siblings, and children because the system is fully recursive, as explained above. In some instances, direct association outside of the “parent child sibling” context must be added, e.g. to a grandparent (as in the case of dealer to OEM).

The database manager 112, as described above, ensures that business entity 130 users 180 only receive permission to access (to view, modify, edit, supplement, create, etc.) records of databases, fields within records, and reports linking and displaying this information (all regarded as “information” made up of “business objects”) that are appropriate for their assigned role within the entity 130 to which they belong. As can be understood from the foregoing, once created, business entities 130 become the nexus from which almost all resources are referenced. These resources include users 180 and databases 172, among others.

An authorized user 180 may be assigned a role with the highest set of system privileges in representing the uppermost branch of the system sponsor 124 network (hereinafter the “designated system administrator”). When the designated system administrator requests or authorizes initial creation of a version of the system 100, certain one-time system settings is initialized via use of a Business Process Executive Language (BEPL) implementation mechanism or otherwise established in the system 100 by techniques known in the art. The active content configuration module 176 may also allow the designated system administrator to select other pre-developed system settings that, once chosen, become static (or fixed) content not amenable to modification after launch of system 100 into production status.

A designated system administrator serving as the initial configurator of the specific version of the system 100 uses the active content configurator 176 to establish initial active content 156 values for the system, such as by selecting from amongst predetermined setting choices or entering new values. In one possible implementation, the necessary initial active content 156 values may be pre-selected by default, enabling the system sponsor 124 to either initiate use of the system 100 without first employing the active content configurator 176, or to have the designated administrator modify certain initial active content 156 values prior to the first use of the system 100. In either case, the initial active content 156 values established by the designated administrator for first use by the system 100 are chosen as default values. The nature of some of the active content 156 configured by the active content configurator 176 to enable specific system 100 functioning is discussed further with reference to FIGS. 5 and 6.

Authorized users 180 may subsequently use the active content configurator 176 to edit default values for any number of reasons. In one example, leads 114 for which rights and action plans may be assigned to lead-handling entities 128 may be processed using a common set of rights assignment rules and referents. However, assigned action plans may need to be specific to one entity 130 based on geographic location, legal considerations and so forth. Thus, an authorized user 180 representing a business entity 130, or group of business entities 130, may need to edit an active content 156 action planning rule because local business practices make an otherwise acceptable industry action, such as communicating a guarantee of a minimum value for the customer's 116 trade-in, impractical. In another example, an active content 156 action planning rule and related action referent may involve a legal disclaimer and need to be modified based on the local legal policies in effect. As can be appreciated, active content 156 values may need to be modified by a user 180 for any number of reasons.

After logging in or otherwise gaining access to the database manager 112, a user 180 who has been assigned a role within the system 100 is allowed, by the active content configurator 176 confirming the privilege (or precedence) of user 180, to edit active content 156 of that version of the system 100. A user 180 may be a representative such as an administrator of a business entity 130 or a group of business entities 130. As noted above, business entities 130 may include system sponsor 124 organizations and lead-handling entities 128 affiliated with the sponsor's network. Editing of active content 156 values is shared between participating entities 130, or groups thereof. As such, different users 180 from different entities 130, or groups thereof, may access and edit values according to privilege (or precedence).

Users 180 may elect to retain the active content 156 values open so that subsequent users 180 may edit the values. Alternatively, a user 180 may wish to lock a value to prevent editing. The active content configurator 176 operates on precedence assigned to the different entities 130, and groups thereof, to determine control of its locked values. Thus, a higher precedence may change a value locked by a lower precedence, and a higher precedence lock is not modifiable by a lower precedence lock. Given the complex natures of business entities and their relationships, pre-assigning precedence greatly facilitates a determination of whether one entity overrides another entity's lock.

Referring to FIG. 4, a table 400 is shown illustrating one methodology for determining the values of active content 156 affecting the manner in which the system processes leads for which rights and action plans may be assigned to a lead-handling entity 128. The active content 156 may include system roles and privileges, lead-related rights and rules, affiliated lead information, lead action plans and rules, or other information that may affect system 100 functioning. Entities 130 participating in a branch of a sponsor's network may need to handle leads 114 processed for them. However, the active content 156 values (or alternatively, “active values 156”) affecting configurable system settings such as roles and privileges, assignment and revocation of lead-related rights, affiliated lead information, and assignment of action plans, may vary for a number of reasons. Thus, an active value 156 must be modifiable according to the specific lead-handling entity 128. Furthermore, a methodology based on precedence enables restriction and control of these active values 156, as will be discussed.

Default values 402 are initially created in a corresponding version of system 100 with the active content configurator 176. Active values 156 shown throughout table 400 are accompanied by a subscript to indicate the provider of the active value 156. Providers are groups 404 of business entities 130 (hereinafter “groups 404”) that are participating in the management of a lead-handling entity 128 within the sponsor's network. A group 404 may include one or more business entities 130. Participation in a group 404 may be based on a number of relational factors such as franchise relations, contractual relations, sponsorship, lead handling relations, and so forth. A user 180 acts in at least one assigned role on behalf of a group 404 to access and modify active values 156 of table 400.

Default values 402, A-J, have a subscript “d” to indicate their default setting. Subscripts “g1, g2, . . . , gN” indicate that a user 180 of a corresponding group 404 in a given role provided a new setting upon modification of the active value 156. Thus, values E-J have a subscript “g1” to indicate that group 1 provided a new active value 156. A “+” symbol in front of a active value 156 indicates that the active value 156 is locked or immutable. A locked active value 156 may be overridden by another locked active value 156 of higher precedence. Active values 156 specified by multiple groups 404 are evaluated based on an order of precedence established for the roles assigned to the users 180 representing the groups 404. In FIG. 4, the precedence order goes down as the group number increases.

In locking, a group 404 with the highest precedence can override a lock by a group 404 of a lower precedence. Value I is locked by group 2. Although group 3 and group N have different active values 156 for I and J, the precedence of group 2 prevents the unlocking and modification of I and J.

For unlocked active values 156, an active value 156 supplied by a lower precedence group may be used. Value H is changed by group 1, group 2, and finally group 3. Because value H was never locked, the last chronological modification determines the active value 156, thus impacting the manner in which the system 100 processes leads for which rights may be assigned to the lead-handling entity 128.

Subscript “s” indicates that a lead-handling entity-specific default value 156 is provided. The active content configurator 176 may automatically modify active values 156 based on predetermined lead-handling entity 128 values. In FIG. 4, the values C and G are modified to a lead-handling entity-specific default value. In one implementation, locked active values 156 override the lead-handling entity-specific default values. This is shown where I and J have locked active values 156 by site group 2. Alternatively, lead-handling entity-specific values may be given precedence as with the groups 404. Lead-handling entity-specific values would then operate similar to the groups 404 in overriding previously established locks.

Subscript “c” indicates a specific instance of a specific lead 114 providing an active value 156, as shown with values B, D, F, I, and J. For example, the system 100 may be implemented such as to capture one or more meta-data values associated with a lead 114 that may be used to configure corresponding active content 156 for the lead 114. Such meta-data may, for example, identify specific fields within the lead 114 whose active values 156 (customer 116 identity, contact information, trade-in vehicle, etc.) are requested to be withheld from a lead-handling entity 128 assigned certain rights to that lead 114. A specific lead 114 may override a lead-handling entity-specific value.

In the implementation shown, a specific lead 114 does not override business entity group 404 locks. However, in alternative embodiments, a specific lead 114 may be assigned a precedence and operate similar in priority to the groups 404. For example, the system 100 may be implemented such as to enable the customer 116 or lead-owning sponsor 124 to assign a precedence for a lead 114 itself, with the precedence value possibly mediated by a “role” associated with that sponsor 124. The precedence assigned to the lead 114, in conjunction with the meta-data values associated with the lead 114, may be used to configure corresponding active content 156 for the lead 114 according to the precedence-based locking mechanism discussed above.

Default values 402 for active content 156 are modifiable by participating groups 404 and automatically replaced by predetermined lead-handling entity-specific values and active values 156 provided by specific leads 114. Active values 156 are locked at the discretion of the groups 404. The control of active values 156 is maintained by the precedence ranking of participating groups 404. Thus, a superior precedence will retain ultimate control over active values 156. In this manner, users 180 representing the highest level of the originating branch of a sponsored network management hierarchy (i.e. “1” in FIG. 4, such as an OEM) determine the active content values 156. This determination may affect the manner in which the system 100 processes all leads 114 for which rights and action plans may be assigned to a lead-handling entity 128, regardless of other participating groups 404. Such other groups 404 may include lower-level network hierarchical branches (zones, regions, districts, etc.), dealership groups, individual retailers, and so forth.

FIG. 5 is a flow chart 500 of one embodiment for configuring the rule referents (or output structure) of the system 100 of FIG. 1. Rule referents pertain to the possible outputs of the system 100 such as the types of rights, lead information, and lead-related actions that may be invoked by the rules engines 144 and 148, and constitute at least part of the system's 100 configurable active content 156.

A person determining the possible referents of the system's rules engines 144 and 148 includes a user 180 assigned a role that has been accorded corresponding system output structure configuration privileges. As noted above, the initial user 180 configuring this aspect of the system 100 may commonly be assigned a role of designated system administrator. The user 180 may be authenticated 502 by the database manager 112, or in some cases, more specifically by the active content configurator 176, as authorized to access to the system 100 for configuration purposes.

Authentication may include identifying the user 180 as having an affiliation with a particular business entity 130, which is tied into the sponsor's network through one or more business associations, and identifying the user 180 as having a particular role. That role will have been mapped to one or more configuration privileges, each having a base precedence value. In one embodiment, the mapping of roles to configuration privileges may be present in a default mode at system initiation, by using a business process language, while being capable of a re-mapping to meet the particular needs of a specific sponsor 124 through a privilege configuration mechanism as described with reference to FIG. 6.

Once authorized to access the active content configurator 176, the user 180 may request 506 an output structure classification (active content 156) to modify. The active content configurator 176 then confirms 506 that the user's 180 role affords the user 180 the privilege to do so. That is, if the active content 156 for the requested output structure classification is locked, the active content configurator 176 verifies 506 that the precedence value of the user 180 entitles the user 180 to override the lock and modify the active content 156. Active content 156 may include lead rights classification 160, lead information classification 164, and lead actions classification 168, in addition to data stored in databases 172. Additionally, “to modify” may be to create or edit 508 a lead-related right-type within the lead rights classification 160 of memory 108. Types of rights that may be created or modified 508 include one or more of the following non-exhaustive possibilities, including a right to work a lead, to view a lead, to edit a lead, to aggregate leads, and/or to close a lead, each discussed below.

Depending on the specific needs of the system sponsor 124, the active content configurator 176 may be implemented in which the default mode is to automatically lock lead rights-type edits 508 made by appropriately privileged users 180 affiliated with groups 404 assigned a certain precedence level, as discussed with reference to FIG. 4. In the alternative, or in addition to, the active content configurator 176 may provide for elective manual locking by the user 180. In either case the effect of locking is a function of the precedence value of the user 180.

In addition, that precedence value may also privilege the authorized user 180 to unlock locked values of the active content 156, thus enabling access and, possibly, modification by other users 180. Such other users 180 may be affiliated with business entities 130 falling beneath the authorized user 180 in the hierarchical network branch of the authorized user 180, which in FIG. 4 means a group 404 having a larger provider number. This active content 156 would have otherwise been unavailable for viewing and/or modification by such other users 180.

However, so long as a first privileged user (“180a”) has a higher precedence value than a second, subordinate privileged user (“180b”), the first user's 180a modifications will cause modified active content 156 to remain locked as to the second user 180b, unless the second user 180b is provided specific unlocking privileges by virtue of its initially configured role, or by a manual changing of the locked value by the first user 180a. A manual change to a locked value may include unlocking the active content 156 as to all privileged users 180, or to users 180 whose roles and business entities accord them a certain minimum precedence value, on a case-by-case basis.

A user 180 may also create or modify 510 sets of lead information. Lead information may include any of a non-exhaustive list of examples, including: a prospect identifier and contact information, a product of interest, prospect demographics, a prospect's financial status and concerns, and lead origin specifics, such as the marketing venue that elicited the lead. In creating or editing 510 lead information, a privileged user 180 may classify “lead information types” by establishing versions (or sets) of lead-related information. For example, one type may consist of a set that includes all of the human readable fields contained in the lead 114, while a second type may consist of a set that includes all human readable fields other than those that provide prospect identity and contact information. The second type may be used as the basis for determining what lead information to expose to a selected lead-handling entity 128 that is only granted the right to view the lead 114. Once sets of lead information are created or modified with reference to a lead 114 and locked values are potentially changed, the new settings are saved.

Once the lead rights and the lead information have been created or modified 508, 510, the active content configurator 176 may map 512 stored lead information 122 with stored lead rights classification 120. Note, however, that the system 100 may dynamically map 512 stored lead information in a database 172 with stored lead rights classification 160, for instance via the lead action planner 136 or lead rights assignor 132, any time before communicating a lead-related right to a lead-handling entity 128. These mapped 512 values may be saved by the user 180 in a database 172.

A further element of configuring the system structure includes creating or modifying 514 one or more lead action types. Lead action types may include, but are not limited to, communicating certain initial message content to a customer 116 prospect (an individual associated with a lead 114), informing the prospect of a financing option, conducting a follow-up phone call or e-mail after initial contact of the prospect, conducting a test drive, conducting a trade-in evaluation, guaranteeing a minimum trade-in value, appending demographic information to the lead, using certain communication methods with the prospect, employing certain rules in closing the lead, and analyzing lead information in a specified manner. These created or modified 514 lead action types may be saved by the user 180 in a lead database 172. Once a user 180 completes user modifications 516, the user 180 may exit 518 the system.

The system 100 also includes mechanisms for harnessing available rules attribute-related information within databases 172, which are configured by appropriately privileged users 180 for use in various ways by one or both of the rules engines 144 and 148 of the lead rights assignor 132 and lead action planner 136, respectively. Rules attribute types, for example, may be used to circumscribe general categories of information that are eligible for use in formulating rules for assigning lead rights, lead information sets, and action plans, and may vary in focus and degree of granularity, among other things. Depending upon the implementation, the approach may be to identify required, excluded, or suggested categories of rules-related attributes in order to facilitate compliance with legal, regulatory, corporate policy, and best practices, among other things.

For instance, certain system configuration privileges may enable a user 180 to select from one or more of the following categories and sub-categories of rules attribute-type information that may be present in various databases 172 for use by one or both of rules engines 144 and 148: Customer—prospect identity, purchasing history, demographic or financial characteristics; Lead-handling Entity—general business characteristics, personnel, staffing levels, inventory levels, or lead response outcome history; Lead-Response Action Plan—communication methods, communication content, trade-in processes, financing processes; Lead—general content, anticipated down payment, monthly payment, or trade-in vehicle; OEM—marketing programs, rebates, or vehicle financing options.

From among the selected rules-related attribute types, privileged users 180 may identify specific attributes eligible for use in the rules employed by one or both of the rules engines 144 and 148, such as by selecting from within databases 172 specific fields mapped to each of the categories already discussed. For example, for instantiating attributes eligible for use by both rules engines 144 and 148 from within a list of fields mapped to a “customer prospect” attribute type, a user may select from the following: “PROSPECT_LATITUDE_LONGITUDE”, “PROSPECT_PREFERRED_CONTACT_METHOD”, and “PROSPECT_NEEDED_FINANCING_AMOUNT.” “LATITUDE_LONGITUDE” refers to geographical location in any form adapted for use by rules engines 144 and 148. From within a list of fields mapped to a “lead” attribute type, a user 180 may select from the following: “LEAD_DESIRED_MAKE” and “DESIRED_MODEL.” And, from within a list of fields mapped to a “lead-handling entity” attribute type, a user 180 may select from the following: “FRANCHISE_MAKE” and “FRANCHISE_LATITUDE_LONGITUDE.” Establishment of rules attribute types and rules attributes is described in steps 618 and 616 of FIG. 6, and mapping of rules attributes to rules attribute types is described in step 620 of FIG. 6, discussed below.

Using the list of identified attributes, such as specific fields, privileged users 180 create various rules for the rules engines 144 and 148. This may involve selecting the fields used in a particular rule and identifying their threshold active values 156 and the Boolean or other logic that jointly constitute the rule for a given referent. Continuing with the above example, a simple rule for assigning a “work the lead” right may select the lead-handling entity 128 for which the value for “LEAD_DESIRED_MAKE” equals the value for “FRANCHISE_MAKE” and the difference between the value for “PROSPECT_LATITUDE_LONGITUDE” and the value for “FRANCHISE_LATITUDE_LONGITUDE” is the smallest. When rules are triggered, rules engines 144 and 148 cause the lead rights assignor 132 and lead action planner 136 to output the appropriate referents. Creation of rules occurs in step 632 of FIG. 6.

Referring to FIG. 6, displayed is a flow chart 600 for configuring the roles and privileges of users 180 of the sales lead rights assignment and action planning system 100 of FIG. 1. The ability of a user 180 to configure the system 100 may be affected by the user's role-based privileges and, thus, the precedence level of the user's business entity group 404 for that role within a sponsor 124 network, as previously discussed with reference to FIG. 4.

The establishment of roles and privileges, and the assignment of users 180 to roles are steps covered in block 602, which may be implemented by the active content configurator 176 as discussed with reference to FIG. 1. These steps include a user 180, who may be the designated system administrator, establishing 604 various configuration privileges for each of the system's 100 different active content active values 156, such as the ability to view, create, edit, update, delete, and/or lock a particular setting or other business objects in a database field. The privileged user 180 may also establish 606 a set of user 180 roles, and associate 608 each of these roles with a set of one or more of the established 604 system configuration privileges, thus creating at least one potential active value 156 configuration capability for each user 180 assigned a role.

To further implement the ability to extend privileges to employees affiliated with business 130 entities throughout a sponsor's 124 network, the privileged user 180 may also associate 610 individual employees (specific users 180) with a business entity 130 master user role. Privileged users 180 associated with a master user role may, in turn, associate 612 selectable roles with individual employees within business entities 130 in their business entity group 404. This allows a privileged user 180 to allocate one or more system configuration privileges to other users 180 within such a group 404.

The above-described process allows a privileged user 180 to configure 614 the system output structure discussed in detail with reference to FIG. 5. A privileged user 180 may also establish 616 rules attributes, establish 618 rules attribute types, and may map 620 rules attributes to rules attributes types. The attributes and attribute types are drawn from databases 172 of memory 108. For example, lead rights rules utilize rights-related attributes established in step 616. As noted above, rights-related attributes may include, but are not limited to, utilizing specific fields of information about the customer prospects 116, the leads 114 themselves, the business entities 130 participating in the sponsor's 124 network, individuals within a participating business entity 130, generated lead-action plans, undertaken lead actions, and lead-handling outcomes.

Once the system 100 has been configured with proper affiliations between system roles and privileges, a user 180 authorized for active content configurator 176 access seeks 622 to access an active content value 156, which may include a system 100 setting. Authorization requirements may include being authenticated or meeting other security requirements, whether the user 180 seeks view-only access or, for example, access to create, update, delete, or lock an active value 156. The active content configurator 176 also determines 624 whether the user is authorized to access the requested active value 156. If the user 180 is not permitted access, then the process determines 634 whether the user 180 wishes to request access to another active value 156. If the user 180 requests 634 access to another active value 156, the process repeats itself starting at 622, otherwise the process exits.

If the user 180 is permitted access to the requested active value 156, then the active content configurator 176 displays 626 the active value 156 and determines 628 whether the user 180 wishes to modify (for example, create, edit, delete, or lock) the active value 156. If the user 180 does not wish to modify the active value 156, then the process proceeds to step 634 as described above. If the user 180 wishes to modify it, the active content configurator 176 determines 630 whether the user's 180 privileges permit the requested modification, and, if the active value 156 is locked, the precedence value of the user 180 and the precedence value of the active value 156 to be modified. If the precedence value of the user 180 is higher than that of the active value 156, then the requested modification is permitted, as described with reference to FIG. 4. If the requested modification is permitted, the active value 156 is modified 332 and the process proceeds to step 334 as above. If the requested modification is not permitted, the process proceeds to step 334 as above.

Active values 156 modified by the user 180 will then be invoked by the system in the normal course of operation for leads 114 whose rights are routed to selected lead-handling entities 128 affiliated with the user's business entity 130 group 404. Once the system 100 is configured for processing leads in accordance with a proper set of rules as set by appropriately-privileged (and not locked-out) users 180, the system 100 may execute in an automated fashion in accordance with that set of rules.

FIG. 7 illustrates a flow chart of one method 700 for implementing the system 100 of FIG. 1. A lead 114 enters the system 100 through any of a number of vehicles as described with reference to FIG. 1. Method 700 processes 702 the lead 114 through the sponsor's 124 version of a lead processing system 118. That version communicates electronically with the appropriate system 100 for a given lead 114. The method 700 then processes 704 the lead 114 through the system 100 of the sponsor 124 for rights assignment and related lead information. The assignments of lead information with lead rights are stored 706 in a database 172 of memory 108.

The method 700 then determines 708 whether a lead owner uses action planning as part of its implementation of the system 100. If the answer is no, then the lead rights assignments with related lead information is forwarded 710 to the communication module 114. Therefore, the communication module 140 automatically transmits the lead assigned rights and related lead information, which has been effectively passed on to one or more selected lead-handling entities 128. If, however, the sponsor 124 does use an action planning process, then the method 700 processes 712 the lead 114 with the lead action planner 136 for lead actions, which are then used to create or formulate a lead action plan. For example, simple action planning rules may consist of requiring that a lead-handling entity 128 assigned a right to “work the lead” conduct an action of “first contacting the customer by email” if the value for a lead's “PROSPECT_PREFERRED_CONTACT_METHOD” field indicates email, and recommending that it conduct an action of “communicate information about special factory financing” if the value for the lead's “PROSPECT_NEEDED_FINANCING_AMOUNT” field is equal to or greater than $20,000.

Lead action plans are stored 714 in a database 172 of memory 108. Once this action is taken, then the method 700 forwards 716 lead rights assignments to the communication module 140 with attached lead information and one or more associated lead action plans created from required or suggested lead actions. The communication module 140 may automatically transmit these to the selected lead-handling entity 128.

Method 700 may also determine 718 whether the owner's implementation of the system 100 requires monitoring by an assignee performance monitor 184. If the answer is no, then the process exits because the lead was distributed properly with the required affiliated rules, information, and action plans. No more action is required. If, however, monitoring is required, then the performance related to the lead 114 is monitored 720 for one or both of two things. First, right-related aspects of the lead 114 performance may be monitored as discussed with reference to FIG. 1. For example, a rule for revoking an assigned “work the lead” right for a lead 114 may specify that it is triggered if the selected lead-handling entity's value for a monitored “TIME_TO_FIRST_CONTACT” field is not equal to or less than 24 hours OR if its value for a monitored “FIRST_COMMUNICATION_METHOD_EMPLOYED” field does not equal the value for the lead's “PROSPECT_PREFERRED_CONTACT_METHOD” field. Second, if a lead-action plan was developed for a lead 114, then performance related to the lead 114 may be monitored for, among other things, operational needs to inform action planning update rules, analysis, and reporting. Monitored information may be saved 722 in a database 172 to be accessed when required by the lead action planner 132.

If the system 100 decides that the monitored assignee triggered 724 a rights-assignment revocation rule, then method 700 processes 704 the lead 114 again for assignment of the revoked right, with related lead information, to a different lead-handling entity 128. Processing a lead for assignment of revoked rights again is called reassignment, and allows precious leads to be handled more efficiently. That is, the lead 114 would re-pass through method 700 from step 604, for ultimate reassignment of the revoked rights in steps 710 or 716 to another selected entity 128, and may also be monitored in 720, as required, to track performance as discussed above.

For example, many leads 114 are lost because they are not worked (or responded to) in a timely manner, especially where the sales subject matter requires capitalizing on a prospect's buying fever, which is often fleeting. By providing rights-assignment revocation rules, the value of expensively obtained leads 114 is preserved and the higher cost of failed opportunities to make specific sales is avoided. Original equipment manufacturers (OEMs) also benefit because more merchandise is moved so that inventories do not build up and the costs of delay, such as slowing production or offering incentives to move merchandise, are largely avoided.

Rights-assignment revocation rules may be triggered by a failure to contact the customer 116 within a specific period of time, enter periodic statuses, including what steps have been taken in furtherance of working the lead, or complete specific action plan steps required when rights to the lead was distributed to a selected lead-handling entity 128. One skilled in the art could conceive of a variety of rights-assignment revocation rules based on other various criteria.

If the system 100 decides that the selected lead-handling entity 128 triggered 726 a lead action plan update rule, then method 700 processes 708 the lead 114 again for lead-related actions associated with the lead-related rights of the selected lead-handling entity 128. Processing a lead for action plan updating after monitoring triggers a lead action plan update rule is called replanning, and allows precious leads to be handled more efficiently and effectively, such as by generating required or suggested follow-on actions with a higher probability of success based on a knowledge of actions already undertaken. One skilled in the art could conceive of a variety of lead action plan update rules employing branching logic based on a variety of criteria, such as the order in which lead handling actions were undertaken or the initial method of communication employed with the prospect 116.

Finally, if no rights-assignment revocation rule or lead action plan update rule is triggered, the system 100 may then determine 728 if the lead 114 is still open. If the system determines 728 that the lead 114 is still open, the lead 114 continues to be monitored 720 by the system until it is closed, or until rights reassignment or action plan updating eliminates the need to monitor 718 the lead 114.

A cross-entity sales lead rights assignment and action planning system 100 in accordance with the embodiments described herein may enable an OEM, or other lead owning organization with a network of lead-handling business entities 130, to facilitate optimal lead-handling within its network with increased sales velocity and improved closing ratios. Additionally, it rewards effective lead-handling entities 128, such as product vendors, with increased re-routed lead rights assignments, and creates additional incentives to improve lead-handling for entities 128 such as product vendors that do not typically handle leads effectively.

The method 700 and other methods for sales lead rights assignment and action planning with a network of sponsored entities 124, as described herein, may exist in a variety of forms, both active and inactive. For example, they may exist as one or more software or firmware programs comprised of program instructions in source code, object code, executable code or other formats. Any of the above may be embodied on a computer-readable medium, which include storage devices and signals, in compressed or uncompressed form. Exemplary computer-readable storage devices include conventional computer system RAM (random access memory), ROM (read only memory), EPROM (erasable, programmable ROM), EEPROM (electrically erasable, programmable ROM), flash memory and magnetic or optical disks or tapes. Exemplary computer-readable signals, whether modulated using a carrier or not, are signals that a computer system hosting or running a computer program may be configured to access, including signals downloaded through the Internet or other networks. Concrete examples of the foregoing include distribution of software on a CD ROM or via Internet download. In a sense, the Internet itself, as an abstract entity, is a computer-readable medium. The same is true of computer networks in general.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

What is claimed is:

1. A sales lead server accessible over a network and hosting databases containing static and active content related to sales leads, the server comprising:
a network interface for communicating with the network;
a memory to store records of databases containing static content and active content;
a database manager to render databases with the static content and the active content relative to one another, the database manager to perform a method comprising:
enabling a user to create a lead-related right for each lead;
enabling a user to create rules associated with each lead that cause the database manager to assign to a selected lead-handling entity the lead-related right for each lead; and
automatically applying the rules to assign to the lead-handling entity the lead-related right for a lead; and
a communication module in communication with the database manager that automatically communicates to the lead-handling entity the assigned lead-related right to the lead.

2. The server of claim 1, wherein the database manager further comprises an active content configurator for performing the method.

3. The server of claim 1, wherein the database manager further performs:
enabling a user to create rules associated with each lead that cause the database manager to revoke from a selected lead-handling entity the lead-related right for the lead.

4. The server of claim 3, wherein the database manager automatically applies the rules to revoke from the selected lead-handling entity the lead-related right for the lead.

5. The server of claim 4, further comprising a performance monitor in communication with the database manager and with the lead-handling entity, wherein the database manager monitors a status of a selected lead-handling entity's handling of the lead.

6. The server of claim 5, wherein the database manager periodically monitors the selected lead-handling entity's handling of the lead.

7. The server of claim 5, wherein the performance monitor monitors a lead-handling status based on specific criteria.

8. The server of claim 7, wherein the criteria are obtained from one of the performance monitor, a database location, and a rules engine of a lead rights assignor of the database manager.

9. The server of claim 5, wherein the database manager determines whether to revoke the assigned lead-related right from the lead-handling entity based on the monitored status.

10. The server of claim 9, wherein the lead-related right is automatically revoked in response to the selected lead-handling entity's delay in handling the lead.

11. The server of claim 9, wherein the lead-related right is automatically revoked in response to the selected lead-handling entity's failure to enter one or more statuses regarding the selected lead-handling entity's progress in handling the lead.

12. The server of claim 1, wherein the assigned lead-related right includes a right to work the lead.

13. The server of claim 1, wherein the assigned lead-related right includes a right to view the lead.

14. The server of claim 1, wherein the assigned lead-related right includes a right to edit the lead.

15. The server of claim 1, wherein the assigned lead-related right includes a right to close the lead.

16. The server of claim 1, wherein the assigned lead-related right includes a right to aggregate multiple leads.

17. The server of claim 1, wherein the database manager combines associated lead information with the lead-related right when assigned to the lead-handling entity.

18. The server of claim 17, wherein the database manager blocks at least a portion of the lead information from access by the lead-handling entity.

19. The server of claim 1, wherein the database manager further performs:
authorizing a user to access the database manager;
receiving a user request to modify a selected active content;
determining if the selected active content has a locked value;
preventing the assignment of a new value to the selected active content upon determining that the selected active content has a locked value;
comparing a precedence of the user request to a precedence of the locked value; and
assigning a new value to the selected active content if the precedence of the user request is greater than the precedence of the locked value.

20. The server of claim 19, wherein the selected active content is a lead right-type.

21. The server of claim 19, wherein the selected active content is a lead information type.

22. The server of claim 21, wherein the lead information type is mapped to the lead right-type.

23. The server of claim 19, wherein the database manager further performs:
receiving a user request to change the locked value of the selected active content;
comparing the precedence of the user request to the precedence of the locked value; and
assigning a new locked value to the selected active content if the precedence of the user request is greater than the precedence of the locked value.

24. A sales lead server accessible over a network and hosting databases containing static and active content related to sales leads, the server comprising:
a network interface for communicating with the network;
a memory to store records of databases containing static content and active content;
a database manager to render databases with the static content and active content in memory relative to one another, the database manager to perform a method comprising:
enabling a user to create a lead-related action for each lead; and
enabling a user to create rules for action plan creation that identify the lead-related action to be taken by a lead-handling entity having a lead-related right to an identified lead; and
automatically applying the rules to assign lead action plans to the lead-handling entity for lead-related actions associated with the identified lead; and
a communication module in communication with the database manager that automatically communicates to the lead-handling entity the assigned lead action plan associated with the identified lead.

25. The server of claim 24, wherein the database manager further comprises an active content configuration module for performing the method.

26. The server of claim 24, wherein the database manager further performs:
enabling a user to create rules associated with each lead that cause the database manager to update the lead action plan assigned the selected lead-handling entity for the identified lead.

27. The server of claim 26, wherein the database manager automatically applies the rules to update the action plan for the selected lead-handling entity for the identified lead.

28. The server of claim 27, further comprising a performance monitor in communication with the database manager and with the lead-handling entity, wherein the database manager monitors a status of a selected lead-handling entity's handling of the lead.

29. The server of claim 28, wherein the database manager periodically monitors the selected lead-handling entity's handling of the lead.

30. The server of claim 28, wherein the performance monitor monitors a lead-handling status based on specific criteria.

31. The server of claim 30, wherein the criteria are obtained from one of the performance monitor, a database location, and a rules engine of a lead action planner of the database manager.

32. The server of claim 28, wherein the database manager determines whether to update the lead action plan assigned to the lead-handling entity for the identified lead based on the monitored status.

33. The server of claim 32, wherein the lead action plan is automatically updated in response to the lead-handling entity failing to comply with the lead action plan assigned the lead-handling entity with the identified lead.

34. The server of claim 24, wherein the database manager further performs:
authorizing a user to access the database manager;
receiving a user request to modify a selected active content;
determining if the selected active content has a locked value;
preventing the assignment of a new value to the selected active content upon determining that the selected active content has a locked value;
comparing a precedence of the user request to a precedence of the locked value; and
assigning a new value to the selected active content if the precedence of the user request is greater than the precedence of the locked value.

35. The server of claim 34, wherein the selected active content is a lead action type.

36. The server of claim 34, wherein the database manager further performs:
receiving a user request to change the locked value of the selected active content;
comparing the precedence of the user request to the precedence of the locked value; and
assigning a new locked value to the selected active content if the precedence of the user request is greater than the precedence of the locked value.

37. A method for sales lead assignment of leads owned by a sponsor, the method comprising:
processing the leads to attach lead-related rights and corresponding lead information to the leads; and
communicating to a first selected lead-handling entity the lead-related rights and corresponding lead information associated with an identified lead.

38. The method of claim 37, further comprising setting a right-assignment revocation rule that is to govern the first selected lead-handling entity's handling of the identified lead.

39. The method of claim 38, further comprising:
monitoring the first selected lead-handling entity's performance in handling the identified lead;
triggering the right-assignment revocation rule based on criteria for lack of performance; and
in response to triggering the right-assignment revocation rule, automatically revoking a lead-related right from the first selected lead-handling entity.

40. The method of claim 39, wherein automatically revoking the lead-related right is executed by changing the lead-related right status from initiated to discontinued.

41. The method of claim 40, further comprising in response to the lead-related right being revoked, automatically reassigning the lead-related right to a second selected lead-handling entity.

42. The method of claim 37, further comprising:
determining whether the sponsor uses lead action planning;
in response to a sponsor that uses lead action planning, automatically processing leads for lead-related actions;
formulating a first lead action plan commensurate with the lead-related actions; and
automatically communicating the first lead action plan to the first selected lead-handling entity having a lead-related right with respect to the identified lead.

43. The method of claim 42, further comprising setting a lead action plan update rule to be triggered by the status of the first selected lead-handling entity's handling of the identified lead.

44. The method of claim 43, further comprising:
monitoring the first selected lead-handling entity's performance related to the first lead action plan;
triggering the lead action plan update rule based on meeting established lead activity criteria; and
in response to triggering the action plan update rule, automatically updating the current action plan for the first selected lead-handling entity.

45. The method of claim 44, wherein automatically updating the current lead action plan is executed by:
processing the lead again for lead-related actions;
formulating a second lead action plan commensurate with the lead-related actions; and
communicating the second lead action plan to a second selected lead-handling entity having a right related to the identified lead.

46. A computer readable medium having stored thereon computer executable instructions for performing a method for sales lead distribution of leads owned by a sponsor, the method comprising:
processing the leads to attach lead-related rights and corresponding lead information to the leads and storing the leads with the attached lead-related rights and lead information in computer readable memory; and
communicating to a first selected lead-handling entity the lead-related rights and corresponding lead information associated with an identified lead.

47. The computer readable medium of claim 46, the method further comprising:
setting a right-assignment revocation rule that is to govern the first selected lead-handling entity's handling of the identified lead, and
storing the right-assignment revocation rule in computer readable medium.

48. The computer readable medium of claim 47, the method further comprising:
monitoring, electronically, the first selected lead-handling entity's performance in handling the identified lead;
triggering the right-assignment revocation rule based on criteria for lack of performance; and
in response to triggering the right-assignment revocation rule, automatically revoking a lead-related right from the first selected lead-handling entity.

49. The computer readable medium of claim 48, the method further comprising:
in response to the lead-related right being revoked, automatically reassigning the lead-related right to a second selected lead-handling entity; and
storing the reassignment of the lead-related right to the second selected lead-handling entity in computer readable memory.

50. The computer readable medium of claim 46, the method further comprising:
electronically determining whether the sponsor uses lead action planning;
in response to a sponsor that uses lead action planning, automatically processing leads for lead-related actions;
formulating, electronically, at least a first lead action plan commensurate with the lead-related actions; and
communicating the first lead action plan to the first selected lead-handling entity having a lead-related right with respect to the identified lead.

51. The computer readable medium of claim 50, the method further comprising setting a lead action plan update rule to be triggered by the status of the first selected lead-handling entity's handling of the identified lead.

52. The computer readable medium of claim 51, the method further comprising:
monitoring the first selected lead-handling entity's performance related to the first lead action plan;
triggering the lead action plan update rule based on meeting established lead activity criteria; and
in response to triggering the action plan update rule, automatically updating the first lead action plan.

53. The computer readable medium of claim 52, wherein automatically updating the first lead action plan is executed by:
processing the lead again for lead-related actions;
formulating, electronically, at least a second lead action plan commensurate with the lead-related actions; and
communicating the second lead action plan to a second lead-handling entity, the second lead-handling entity having a right related to the identified lead.
